(19) United States
(12) Patent Application Publication
(10) Pub. No.: US 2011/0237986 A1
(43) Pub. Date: Sep. 29, 2011

(54) ARRANGEMENT IN CONNECTION WITH MASSAGING APPARATUS, AND MASSAGING APPARATUS

(75) Inventors: Leena Pesu, Helsinki (FI); Aki Backman, Altdorf (DE); Tapani Taskinen, Espoo (FI); Jouni Teittinen, Naantali (FI); Kari Salminen, Turku (FI)

(73) Assignee: HLD HEALTHY LIFE DEVICES LTD, Espoo (FI)

(21) Appl. No.: 13/131,412

(22) PCT Filed: Nov. 20, 2009
(86) PCT No.: PCT/FI2009/050943

§ 371 Date: May 26, 2011

(30) Foreign Application Priority Data
Nov. 26, 2008 (FI) 20086130

(51) Int. Cl. A61H 7/00

(52) U.S. Cl. 601/6

(57) ABSTRACT

The invention relates to an arrangement in connection with a massaging apparatus, and a massaging apparatus. The massaging apparatus includes a treatment head (2), a low-pressure chamber (6) arranged at the treatment head, element (5) for producing low pressure in the low-pressure chamber, and a nozzle part (3), one end of which is arranged to be in connection with the low-pressure chamber and the other end of which is arranged to be pressed against a skin tissue to direct low-pressure suction to the skin tissue, thus producing a bulge in the skin tissue. The nozzle part (3) is arranged to form a suction opening with two main axes, which are substantially perpendicular to one another and are of the same or a different length. The arrangement includes a sealing part (4) made of a flexible material and arranged to adapt to the shape of the suction opening formed by the nozzle part and to seal the gap between the end of the nozzle part and the skin tissue when the end of the nozzle part is pressed against the skin tissue. The surface of the sealing part (4) to be pressed against the skin tissue is arranged to be concave in the direction of at least one of the main axes of the suction opening formed by the nozzle part (3).

The invention relates to an arrangement in connection with a massaging apparatus, the apparatus comprising a treatment head, a low-pressure chamber arranged at the treatment head, means for producing low pressure in the low-pressure chamber, and a nozzle part, one end of which is arranged to be in connection with the low-pressure chamber and the other end of which is arranged to be pressed against a skin tissue to direct low-pressure suction to the skin tissue, thus producing a bulge in the skin tissue, whereby the nozzle part is arranged to form a suction opening with two main axes which are substantially perpendicular to one another and are of the same or a different length, and the arrangement comprising a sealing part made of a flexible material and arranged to adapt to the shape of the suction opening formed by the nozzle part and seal the gap between the end of the nozzle part and the skin tissue when the end of the nozzle part is pressed against the skin tissue. The invention further relates to a massaging apparatus.

Massage affects skin and muscles in various ways. Massage is a pressing movement applied to soft tissues for treatment purposes, and it is performed in the form of stroking, rubbing, squeezing and different types of tapping. Traditionally, massage aims at improving the metabolism of the musculoskeletal system, relaxing the tension of muscles and maintaining working capacity. Traditionally massage is done by hands, i.e. by handling the skin tissue by manually performed procedures in the above-mentioned manner.

Nowadays massage treatment is performed manually or additionally, more and more often, with different kinds of devices. Certain procedures are carried out solely by means of devices.

In addition to traditional relaxing purposes, the abovementioned devices may also be used for plastic and corrective treatment, rheumatic problems, burn injuries, treatment of blood circulation problems, swelling and cellulite, stimulation of the circulation of lymphatic fluids, for relaxing and firming tissues and treatment of fibromyalgia. Subcutaneous suction massage of fat and connective tissues stimulates metabolism and blood circulation and restores the firmness of tissues, and removes cellulite, swelling and muscle tension. The treatment also produces positive results for fibromyalgia pains, scar tissue problems, conditions resulting from sports activities, insomnia, and stress.

In the above apparatuses, the massaging method depends on the treatment to be performed. Suction treatment is used especially for treating skin problems, such as cellulite. It is performed using a device consisting of a treatment head, which is moved on the skin and connected to the suction apparatus with a flexible cord in order to create a low pressure on the skin as the treatment head moves against the patient's body. Low pressure is produced in a low-pressure chamber with an open bottom and provided in connection with the treatment head. The open part of the low-pressure chamber is pressed against the skin tissue, whereby the low pressure affects the skin tissue.

The prior art teaches apparatuses, in which the low-pressure chamber is connected with roller means which are pressed against the skin tissue, as well as apparatuses, in which the low-pressure chamber is provided with a surface, which is pressed against the skin tissue and glides on top of the skin tissue as the treatment head is moved on the surface of the skin tissue.

Examples of the above apparatuses known in the field are described in FI patent publication 119098 and US patent application 2007/0027411 A1.

A problem with apparatuses known in the field is, for instance, that the sealing of the low-pressure chamber has not been optimal in each situation, an this has led to a poorer treatment result. The problem is due to the fact that the elastic properties of the surface of the skin tissue are fairly often variable and the skin tissue also curves strongly in different directions. The radius and direction of curvatures of the skin tissue surface may also vary quite much in different parts of the body, wherefore it has been problematic to achieve a sufficient sealing for the low-pressure chamber with prior art apparatuses.

The purpose of the invention is to provide an arrangement in connection with a massaging apparatus and a massaging apparatus, by which the prior art disadvantages can be eliminated. This is achieved by an arrangement and massaging apparatus of the invention. The arrangement in connection with a massaging apparatus, as claimed in the invention, is characterized in that the surface of the sealing part to be pressed against the skin tissue is arranged to be concave in the direction of at least one of the main axes of the suction opening formed by the nozzle part. The massaging apparatus of the invention is characterized in that the surface of the sealing part to be pressed against the skin tissue is arranged to be concave in the direction of at least one of the main axes of the suction opening formed by the nozzle part.

The invention provides particularly the advantage that a sufficient sealing of the low-pressure chamber against the skin tissue can be achieved very efficiently. The invention also provides the advantage that it is simple, whereby the implementation and use of the invention become advantageous. Another advantage of the invention is its flexibility, due to which the invention can preferably be arranged to function in connection with very different kinds of nozzle parts, which allows a good treatment result to be achieved in different parts of the patient's body in an advantageous manner.

The invention will be explained in the following in more detail by means of examples shown in the attached drawing, in which

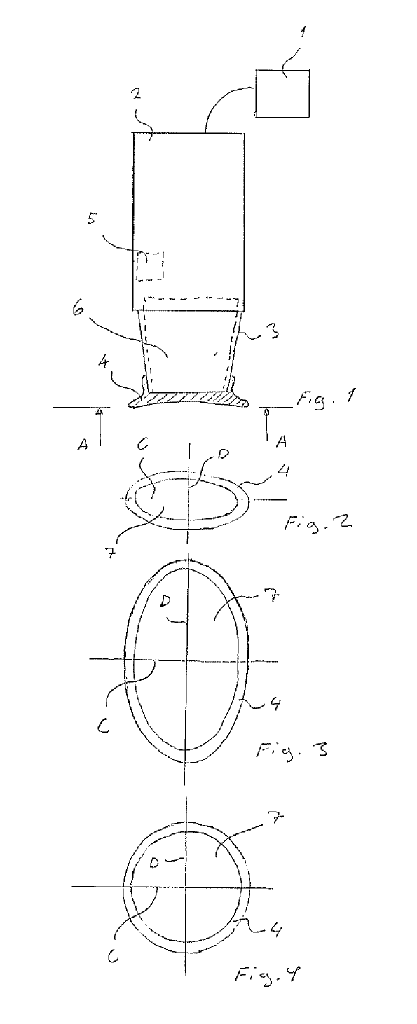

FIG. 1 shows a schematic side view of an embodiment of a massaging apparatus according to the invention,

FIG. 2 shows a schematic view of an embodiment of FIG. 1 in the direction A-A of the arrows,

FIG. 3 shows a schematic view of a second implementation of the embodiment of FIG. 1 in the direction A-A of the arrows,

FIG. 4 shows a schematic view of a third implementation of the embodiment of FIG. 1 in the direction A-A of the arrows,

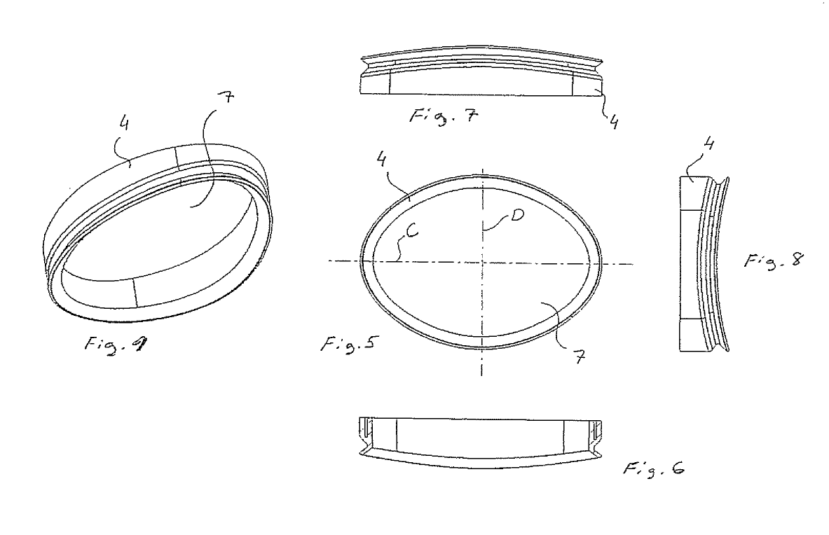

FIGS. 5 to 9 show an implementation of a sealing part of a nozzle part of the arrangement and massaging apparatus according to the invention from different directions, and

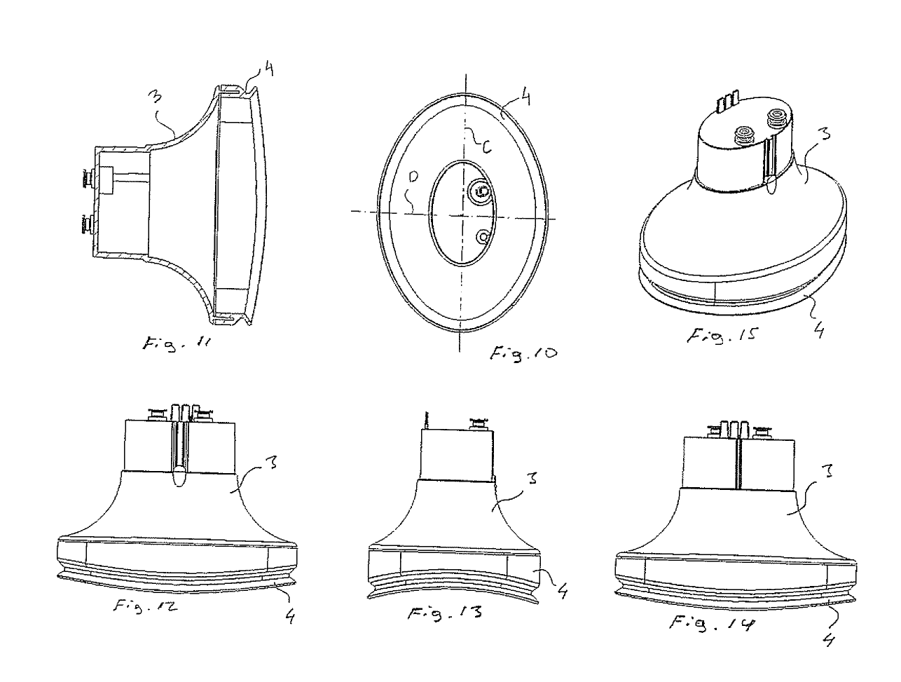

FIGS. 10 to 15 show the embodiment of FIGS. 5 to 9 fastened to the nozzle part from different directions.

FIG. 1 shows an embodiment of the arrangement and massaging apparatus according to the invention schematically. Reference numeral 1 refers to a central processing unit, reference numeral 2 to a treatment head, reference numeral 3 to a nozzle part, and reference numeral 4 to a sealing part.

As shown by FIG. 1, the massaging apparatus thus comprises the treatment head 2 connected to the central processing unit 1. The central processing unit may be a separate entity or arranged in connection with the treatment head. The treatment head is also connected with a low-pressure chamber 5 and means 6 for producing low pressure in the low-pressure chamber. The low-pressure chamber 5 and the means 6 for producing low pressure in the low-pressure chamber 5 are shown schematically by broken lines in FIG. 1.

The massaging apparatus also comprises a nozzle part 3, one end of which is arranged to be in connection with the low-pressure chamber and the other end of which is arranged to be pressed against the skin tissue to direct low-pressure suction to the skin tissue, thus producing a bulge in the skin tissue. In FIG. 1, the end of the nozzle part 3 that is arranged to be pressed against the skin tissue is the lower end of the nozzle part.

The nozzle part is arranged to form a suction opening 7 with two main axes C and D which are substantially perpendicular to one another and are of the same or a different length. The suction opening 7 and the main axes C and D are shown in FIGS. 2 to 4.

The arrangement and the massaging apparatus further comprise a sealing part 4 made of a flexible material and arranged at the end of the nozzle part that is arranged to be pressed against the skin tissue and to adapt to the shape of the suction opening formed by the nozzle part and to seal the gap between the end of the nozzle part and the skin tissue when the end of the nozzle part is pressed against the skin tissue.

The sealing part may be made of any suitable flexible material, such as polyurethane or elastomeric material. The use of other plastic materials and silicon material is also possible. At the sealing part, it is naturally also possible to use a suitable material that reduces or increases the friction between the sealing part and the skin tissue, and/or a material that improves the sealing, depending on whether the objective is to achieve a good mobility for the treatment head or as high a friction force as possible. It is also obvious that these properties may also be achieved by selecting the material of the sealing part suitably.

According to the essential idea of the invention, the surface of the sealing part 4 to be pressed against the skin tissue is arranged to be concave in the direction of at least one of the main axes C or D of the suction opening 7 formed by the nozzle part 3. The concavity of the above-mentioned surface is shown in FIG. 1, for example.

In the application according to FIGS. 1 and 2, the surface of the sealing part 4 to be pressed against the skin tissue is concave in the direction of the longer main axis C of the suction opening 7 formed by the nozzle part 3.

In the application according to FIGS. 1 and 3, the surface of the sealing part 4 to be pressed against the skin tissue is concave in the direction of the shorter main axis D of the suction opening 7 formed by the nozzle part 3.

In the applications according to FIGS. 1, 2 and 3, the shape of the suction opening 7 is elliptical or oval. However, this is not the only feasible embodiment but other shapes may be used as well. An example of this is the embodiment according to FIGS. 1 and 4, in which the suction opening 7 is round. In this application, too, the surface of the sealing part 4 that is pressed against the skin tissue is concave in the direction of one of the main axes C or D of the suction opening 7 formed by the nozzle part 3.

FIGS. 5 to 9 show an embodiment of the sealing part 4 of the arrangement and massaging apparatus according to the invention from different directions and as a perspective view. The same reference numerals are used in FIGS. 5 to 6 as in FIGS. 1 to 3 to refer to the corresponding parts. FIGS. 5 to 9 clearly show the concavity of the surface of the sealing part 4 that is pressed against the skin tissue in the direction of at least one of the main axes of the suction opening 7. In the embodiment of FIGS. 5 and 9, the surface of the sealing part 4 to be pressed against the skin tissue is concave in the direction of the main axis D.

FIGS. 10 to 15 show the sealing part 4 of FIGS. 5 to 9 in connection with the nozzle part 3. The same reference numerals are used in FIGS. 10 to 15 as in FIGS. 1 to 9 to refer to the corresponding parts.

In the above examples, the sealing part 4 is shown as a separate part fastened to the end of the nozzle part. The sealing part 4 may be a disposable part, which is detached after use and replaced by a new one in the beginning of the treatment of a new patient. The fastening to the end of the nozzle part may be achieved by means of various connections. At the end of the nozzle part there may be a flange in the radial direction, which is used for fastening the sealing part made of a flexible material to its place. Thus, the connection shown in the figures is only to be understood as an example and not as a factor limiting the invention. It is also to be noted in this context that the invention may also be applied in such a manner that the sealing part 4 is formed as an integral part of the nozzle part, for instance.

The invention is thus not restricted to the examples of the figures in any way, but the invention may be varied entirely freely within the scope of the claims. Thus, it is obvious that the invention is by no means restricted to any specific shape or dimension of the nozzle part or other components, for instance, but the shape and/or dimensions of the different elements and parts of the invention may differ from one another freely, if desired. The idea of the invention may also be applied in connection with such treatment heads at which roller means are employed.

1. An arrangement in connection with a massaging apparatus, the apparatus comprising a treatment head (2), a low-pressure chamber (6) arranged at the treatment head, means (5) for producing low pressure in the low-pressure chamber, and a nozzle part (3), one end of which is arranged to be in connection with the low-pressure chamber and the other end of which is arranged to be pressed against a skin tissue to direct low-pressure suction to the skin tissue, thus producing a bulge in the skin tissue, whereby the nozzle part (3) is arranged to form a suction opening (7) with two main axes (C, D) which are substantially perpendicular to one another and are of the same or a different length, and the arrangement comprising a sealing part (4) made of a flexible material and arranged to adapt to the shape of the suction opening (7) formed by the nozzle part and seal the gap between the end of the nozzle part and the skin tissue when the end of the nozzle part is pressed against the skin tissue, characterized in that the surface of the sealing part (4) to be pressed against the skin tissue is arranged to be concave in the direction of at least one of the main axes (C, D) of the suction opening (7) formed by the nozzle part (3).

2. An arrangement as claimed in claim 1, characterized in that the surface of the sealing part (4) to be pressed against the skin tissue is concave in the direction of the longer main axis (C) of the suction opening (7) formed by the nozzle part (3).

3. An arrangement as claimed in claim 1, characterized in that the surface of the sealing part (3) to be pressed against the skin tissue is concave in the direction of the shorter main axis (D) of the suction opening (7) formed by the nozzle part (3).

4. An arrangement as claimed in claim 1, characterized in that the surface of the sealing part (4) to be pressed against the skin tissue is formed as a sliding surface with a low friction force or a surface with a high friction force.

5. A massaging apparatus comprising a treatment head (2), a low-pressure chamber (6) arranged at the treatment head, means (5) for producing low pressure in the low-pressure chamber, and a nozzle part (3), one end of which is arranged to be in connection with the low-pressure chamber and the other end of which is arranged to be pressed against a skin tissue to direct low-pressure suction to the skin tissue, thus producing a bulge in the skin tissue, whereby the nozzle part (3) is arranged to form a suction opening (7) with two main axes (C, D) which are substantially perpendicular to one another and are of the same or a different length, and the massaging apparatus further comprising a sealing part (4) made of a flexible material and arranged to adapt to the shape of the suction opening (7) formed by the nozzle part (3) and seal the gap between the end of the nozzle part and the skin tissue when the end of the nozzle part is pressed against the skin tissue, characterized in that the surface of the sealing part (4) to be pressed against the skin tissue is arranged to be concave in the direction of at least one of the main axes (C, D) of the suction opening (7) formed by the nozzle part (3).

6. A massaging apparatus as claimed in claim 5, characterized in that the surface of the sealing part (4) to be pressed against the skin tissue is concave in the direction of the longer main axis (C) of the suction opening (7) formed by the nozzle part (3).

7. A massaging apparatus as claimed in claim 5, characterized in that the surface of the sealing part (4) to be pressed against the skin tissue is concave in the direction of the shorter main axis (D) of the suction opening (7) formed by the nozzle part (3).

8. A massaging apparatus as claimed in claim 5, characterized in that the surface of the sealing part (4) to be pressed against the skin tissue is formed as a sliding surface with a low friction force or a surface with a high friction force.
